(19) United States
(12) Patent Application Publication
(10) Pub. No.: US 2025/0026291 A1
(43) Pub. Date: Jan. 23, 2025

(54) FRONT STRUCTURE OF VEHICLE

(71) Applicant: MITSUBISHI JIDOSHA KOGYO KABUSHIKI KAISHA, Tokyo (JP)

(72) Inventors: Masaru OHKADO, Tokyo (JP); Yudai YAMASHITA, Tokyo (JP); Kenta NAKANISHI, Tokyo (JP); Ryo TOKIZANE, Tokyo (JP)

(73) Assignee: MITSUBISHI JIDOSHA KOGYO KABUSHIKI KAISHA, Tokyo (JP)

(21) Appl. No.: 18/713,964

(22) PCT Filed: Dec. 19, 2022
(86) PCT No.: PCT/JP2022/046645

§ 371 Date: May 28, 2024

(30) Foreign Application Priority Data
Jan. 7, 2022 (JP) 2022-001619

(51) Int. Cl. B60R 19/34

(52) U.S. Cl. CPC B60R 19/34

(57) ABSTRACT

A pair of left and right front side members (1) each have a front end to which an upper crash box (4) is fastened via flange portions (1a, 4a). A pair of left and right front suspension members (7) are disposed below the front side members (1). Each of the front suspension members (7) has a front end to which a lower crash box (10) is fastened via flange portions (7a, 10a) by inner and outer fastening portions (13out) arranged diagonally. The upper crash box (4) and the lower crash box (10) respectively have front ends that are connected via a bumper reinforcement side (15). Each of the fastening portions (13in, 13out) is spaced apart from an outer surface of the lower crash box (10) to facilitate deformation of the flange portions (7a, 10a). At a time of a slight-wrap frontal collision, the lower crash box (10) is rotationally displaced in a plan view while the flange portions (7a, 10a) are deformed, to promote lateral shift of a vehicle body.

### TECHNICAL FIELD

The present invention relates to a front structure of a vehicle.

### BACKGROUND ART

As a conventional front structure of this type of vehicle, for example, Patent Document 1 discloses a structure in which a crash box is provided at the front end of each of a pair of left and right side members configuring a subframe to absorb a collision load at a time of a frontal collision of the vehicle. A fixed flange member is provided at the front end of the side member, a coupling flange member is provided at the rear end of the crash box, and these flange members are aligned and fastened with bolts and nuts.

A horizontally elongated flange is integrally formed for the nuts on the fixed flange member side, and a short side of the horizontally long flange is directed toward a front suspension member. Such a horizontally elongated flange is used to suppress deformation of the coupling flange member when a vehicle has a frontal collision and a collision load is input to the crash box, and to suppress collapse of the crash box due to the deformation of the coupling flange member.

### PRIOR ART DOCUMENT

### Patent Document

Patent Document 1: Japanese Patent Laid-Open No. 2010-202093

### SUMMARY OF THE INVENTION

### Problem to be Solved by the Invention

The horizontally elongated flange of Patent Document 1 is intended to suppress the crash box from collapsing and thereby obtaining the desired effect of absorbing collision load. Therefore, at a time of a full-wrap frontal collision, the crash box is crushed and absorbs the collision load while transmitting the load to the subframe side, to contribute to improving the load-bearing capacity in a vehicle body front-rear direction. However, this is not sufficient to deal with offset frontal collisions.

In an offset frontal collision in which another vehicle or obstacle collides with a part away from the center of a vehicle body front surface, especially a slight-wrap frontal collision in which an overlap amount is small (for example, 25% overlap amount), another vehicle or an obstacle collides with a part on a vehicle width outer side than either the left or right side member. This may prevent a collision load from being input head-on to the crash box, prevent the desired crushing, and in turn, prevent the resulting collision load from being transmitted toward the subframe. Therefore, in an offset frontal collision, there is still room for improvement in terms of improving the load-bearing capacity in the vehicle body front-rear direction.

The present invention has been made to solve such problems, and an object thereof is to provide a front structure of a vehicle that can effectively use a crash box to reduce a vehicle body deformation amount at a time of an offset frontal collision.

### Means for Solving the Problem

In order to achieve the above object, a front structure of a vehicle according to the present invention includes: a pair of left and right front suspension members that constitute a subframe of a vehicle body; and a pair of left and right first crash boxes respectively connected to front ends of the respective front suspension members, in which each of the first crash boxes is connected to the front suspension member so that a front portion of the first crash box is rotationally displaced toward a vehicle width outer side when a collision load is input to the vehicle body due to an offset frontal collision.

Therefore, an offset frontal collision with another vehicle or an obstacle inputs a collision load to either the left or right first crash box. At this time, the first crash box is rotationally displaced so as to move its front end toward the vehicle width outer side, and is placed between the front end of the front suspension member and another vehicle or an obstacle so as to press against both of them. The collision load, which is transmitted from such a first crash box to the front end of the front suspension member, causes a lateral shift of the vehicle body, thereby improving a vehicle body passing-over effect.

As another aspect, the front structure of the vehicle may further includes: a pair of left and right front side members respectively disposed above the front suspension members; a pair of left and right second crash boxes respectively connected to front ends of the front side members; and a pair of left and right bumper reinforcement sides that connects front ends of the first crash box and front ends of the second crash box on both left and right sides of the vehicle body, respectively.

Therefore, the collision load at a time of an offset frontal collision is input to the second crash box as well as the first crash box. The resulting rotational displacement of the second crash box is transmitted to the first crash box via the bumper reinforcement side.

As still another aspect, each of the second crash boxes may have a shape that expands toward a vehicle width outer side toward front.

Therefore, the second crash box, which has a shape that expands toward the vehicle width outer side toward the front, can even receive a collision to more outer side in the vehicle width, and is more likely to generate a rotational force when a collision load is input.

As still another aspect, each of the front suspension members may have a base portion that has a front region with an outer side surface having a shape that extends toward the front and toward a vehicle width outer side.

Therefore, rotational displacement of the first crash box gradually reduces an angle between its outer side surface and the outer side surface of the front region of the base portion of the front suspension member. Then, in a state in which their outer side surfaces are substantially in a straight line, the collision load is transmitted from the first crash box to the front end of the front suspension member. Therefore, the collision load can be efficiently used for bending and deforming the front suspension member.

As still another aspect, there may be a configuration such that: the front suspension members and the first crash boxes each includes a base portion and a flange portion, the base portion extending in a vehicle body front-rear direction, the flange portion extending outward from an end portion of the base portion; each front suspension member and the first crash box connected thereto respectively have the flange portions that are aligned with each other to be fastened by fastening portions at a plurality of positions; the fastening portions include at least an inner fastening portion located on a vehicle width inner side and an outer fastening portion located on a vehicle width outer side; and the inner fastening portion is spaced apart from an outer surface of the base portion of the front suspension member and an outer surface of the base portion of the first crash box.

Therefore, since the inner fastening portion is spaced apart from the outer surface of the base portion of the front suspension member and the outer surface of the base portion of the first crash box, the regions of the flange portions located between these can be deformed, while maintaining the fastening by the inner fastening portion. The base portion of the first crash box is rotationally displaced around the outer end portions while causing the inner end portions to be spaced apart from each other. However, the deformation of the flange portions allows the inner end portions to be spaced apart from each other without damaging the inner fastening portion.

As still another aspect, the inner fastening portion and the outer fastening portion may be arranged diagonally in a cross section of the first crash box.

This causes the flange portions to be fastened by the inner and outer fastening portions arranged diagonally in the cross section of the first crash box, to be reliably aligned to each other, and reduces the number of fastening portions, resulting in reduced manufacturing cost.

As still another aspect, the outer fastening portion may be arranged on a vehicle width inner side relative to an outer end portion of the base portion of the front suspension member and an outer end portion of the base portion of the first crash box.

Therefore, the outer end portion is bent and deformed without being hindered by the outer fastening portion, and even if the outer end portion is bent and deformed, the outer fastening portion is hardly affected.

As still another aspect, a power plant of the vehicle may be disposed on a vehicle width inner side of the front suspension members so as to be adjacent to the front suspension members.

This causes the collision load transmitted from the first crash box to bend and deform the front suspension member, and then causes one side of the front suspension member to come into contact with and press the power plant. Therefore, a lateral shift of the vehicle body is likely to occur.

### Advantageous Effect of the Invention

The front structure of the vehicle of the present invention allows the vehicle body deformation amount to be reduced by effectively using the crash box at a time of an offset frontal collision.

### BRIEF DESCRIPTION OF THE DRAWINGS

FIG. 1 is a perspective view of a front structure of a vehicle according to an embodiment as seen diagonally from the front left.

FIG. 2 is a perspective view of the front structure of the vehicle as seen diagonally from the rear left.

FIG. 3 is a bottom view of a vehicle body including a left front suspension member and a left lower crash box.

FIG. 4 is an explanatory diagram corresponding to FIG. 3 seen from below, showing a left front side member and a left upper crash box.

FIG. 5 is a cross-sectional view taken along a line V-V in FIG. 2 showing an arrangement of inner and outer fastening portions with respect to outer surfaces of the left front suspension member and the lower crash box.

FIG. 6 is a schematic diagram seen in a direction of an arrow A in FIG. 5, showing flange portions without deformation at a normal time.

FIG. 7 is a side view showing a deformed state of the front suspension member and the lower crash box at a time of a slight-wrap frontal collision.

FIG. 8 is a bottom view corresponding to FIG. 3, showing a deformed state of the front suspension member and the lower crash box at a time of a slight-wrap frontal collision.

FIG. 9 is a schematic diagram corresponding to FIG. 6, showing a deformed state of the flange portions at a time of a slight-wrap frontal collision.

FIG. 10 is a diagram showing a result of a test comparing occurrence of amounts of vehicle body lateral shift at a time of a slight-wrap frontal collision between the embodiment and a conventional example.

FIG. 11 is a diagram showing a result of a test comparing amounts of collision energy absorbed at a time of a slight-wrap frontal collision between the embodiment and the conventional example.

### MODE FOR CARRYING OUT THE INVENTION

The following describes an embodiment of a front structure of a vehicle embodying the present invention.

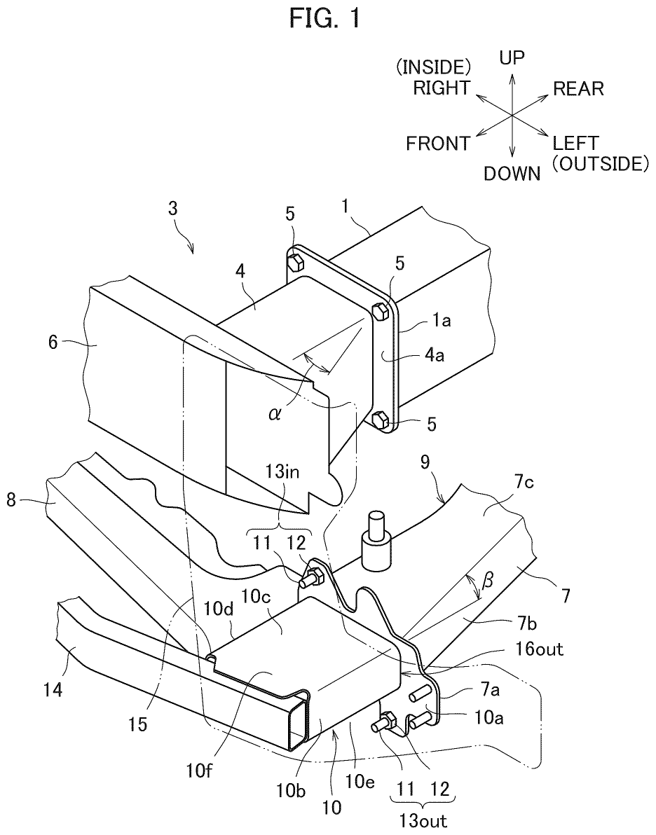

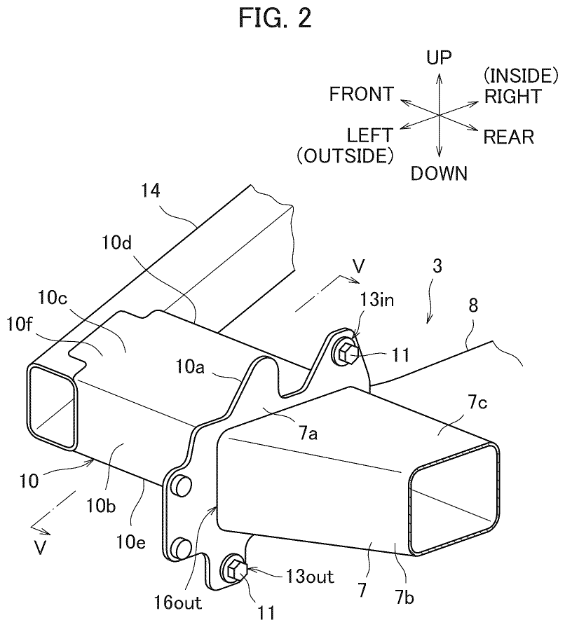

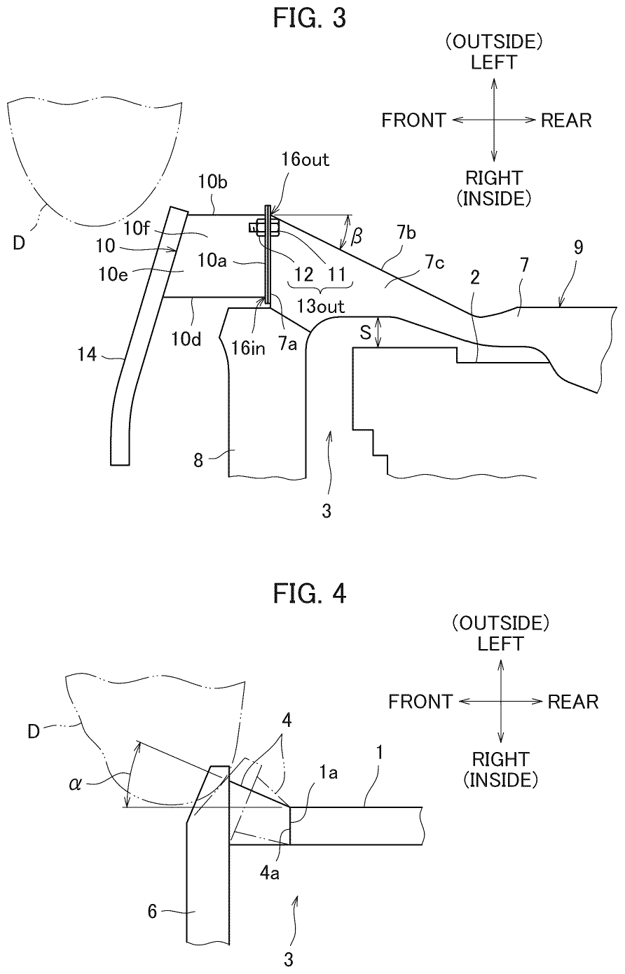

FIG. 1 is a perspective view of the front structure of the vehicle according to the present embodiment as seen diagonally from the front left; FIG. 2 is a perspective view thereof as seen diagonally from the rear left; FIG. 3 is a bottom view of a vehicle body including a left front suspension member and a left lower crash box; and FIG. 4 is an explanatory diagram corresponding to FIG. 3 seen from below, showing a left front side member and a left upper crash box. In the following description, front and rear, left and right, and up and down directions will be expressed with reference to a driver in the vehicle. Furthermore, although each figure mainly shows a configuration on the left side, the right side also has the same symmetrical configuration.

A pair of left and right front side members 1 (only the left side is shown) are disposed as frame members configuring the vehicle body. Between both the front side members 1, an engine room 3 is defined that accommodates a power plant 2 (shown in FIG. 3) including a motor and a speed reducer. Each front side member 1 has a front side where an upper crash box 4 (corresponding to a “second crash box” of the present invention) is disposed. The front side member 1 has a front end to which a flange portion 1a is welded, and each upper crash box 4 has a rear end to which a flange portion 4a is welded. Four corners of each of the flange portions are fastened to each other by bolts 5 and nuts (not shown). The left and right upper crash boxes 4 respectively have front sides that are bridged by a bumper reinforcement upper 6, and the bumper reinforcement upper 6 has both the left and right end portions respectively welded to the upper crash boxes 4. As a result, the left and right end portions of the bumper reinforcement upper 6 are respectively connected to the front ends of the front side members 1 via the upper crash boxes 4.

Each upper crash box 4 of the present embodiment has a rectangular cross section and a shape expanding toward the front in a plan view. In detail, taking the left upper crash box 4 shown in FIG. 4 as an example, the right side surface (inner side surface) of the upper crash box 4 is formed along the right side surface (inner side surface) of the front side member 1 extending in the front-rear direction as shown by a solid line in the figure. In contrast, the left side surface (outer side surface) of the upper crash box 4 is formed at an angle α with respect to the left side surface (outer side surface) of the front side member 1 extending in the front-rear direction. As a result, the left upper crash box 4 has a shape that expands toward the left toward the front, in other words, its left side surface bulges out to the left with respect to the left side surface of the front side member 1. Although not shown or described, the right upper crash box 4 also has the same symmetrical shape.

The shape of the upper crash box 4 is designed assuming a slight-wrap frontal collision of the vehicle. In other words, the upper crash box 4 bulging out to the vehicle width outer side is intended for causing even a collision load on the vehicle width outer side to be input to the upper crash box 4 as much as possible and causing the collision load to rotationally displace the upper crash box 4.

A pair of left and right front suspension members 7 (only the left side is shown) are respectively disposed below the left and right front side members 1. These front suspension members 7 are connected to each other at their front portions via a front cross member 8, and are connected to each other at their rear portions via a rear cross member (not shown). This configures a subframe 9, which supports left and right front suspensions (not shown). The left and right front suspension members 7 are respectively disposed on the opposite sides of the power plant 2. As shown in FIG. 3, there is a gap S formed between the left front suspension member 7 and the power plant 2 in the vehicle width direction. Although not shown, the same gap S is also formed between the right front suspension member 7 and the power plant 2.

A lower crash box 10 (corresponding to a “first crash box” of the present invention) is disposed on each of the front sides of the left and right front suspension members 7. The left and right front side members 1 and the left and right front suspension members 7 are disposed at substantially the same position in the vehicle width direction (at positions coinciding with each other in a top view). Furthermore, the left and right upper crash boxes 4 and the left and right lower crash boxes 10 are disposed at substantially the same positions in the vehicle width direction (at positions coinciding with each other in a top view).

Each front suspension member 7 includes a tubular body portion 7c and a plate-shaped flange portion 7a. The body portion 7c extends in the front-rear direction and has a front end to which the flange portion 7a is welded, and the flange portion 7a extends outward from the front end. Each lower crash box 10 includes a tubular body portion 10f and a plate-shaped flange portion 10a. The body portion 10f extends in the front-rear direction and has a rear end to which a flange portion 10a is welded, and the flange portion 10a extends outward from the rear end. The flange portions 7a and 10f are aligned, and fastened to each other by fastening portions 13in and 13out consisting of bolts 11 and nuts 12.

The body portions 10f of the left and right lower crash boxes 10 respectively have front sides that are bridged by a bumper reinforcement lower 14. The bumper reinforcement lower 14 are located below the bumper reinforcement upper 6. The left and right end portions of the bumper reinforcement lower 14 are respectively welded to the body portions 10f of the lower crash boxes 10. As a result, the left and right end portions of the bumper reinforcement lower 14 are respectively connected to the front ends of the body portions 7c of the front suspension members 7 via the body portions 10f of the lower crash boxes 10.

As shown in FIG. 3, the body portions 7c of the left and right front suspension members 7 each has a front region, the outer side surface 7b of which extends substantially linearly toward the front and toward the vehicle width outer side in a plan view. Such a shape of the body portion 7c of the front suspension member 7 is designed assuming a slight-wrap frontal collision of the vehicle, so as to input even a collision with another vehicle or an obstacle (hereinafter collectively referred to as a colliding object D) to a vehicle width outer side, to the body portion 10f of the lower crash box 10, as much as possible. This prevents the colliding object D from moving through to the rear on the vehicle width outer side of the front suspension member 7, and further prevents the collision load from the colliding object D from being input to the side sill side via the front wheels. As shown in FIG. 3, there is an angle β formed between: an outer side surface 7b of the body portion 7c of the front suspension member 7 extending obliquely; and the outer side surface 10b of the body portion 10f of the lower crash box 10 extending in the front-rear direction.

As shown by dash-dot-dot line in FIG. 1, bumper reinforcement sides 15 are respectively disposed on the left and right sides of the vehicle body. The upper part of each bumper reinforcement side 15 is fastened to the bumper reinforcement upper 6, and the lower part thereof is fastened to the bumper reinforcement lower 14, by bolts and nuts. As a result, the front end of the upper crash box 4 and the front end of the lower crash box 10 are connected to each other via the bumper reinforcement side 15 on each of the left and right sides of the vehicle body.

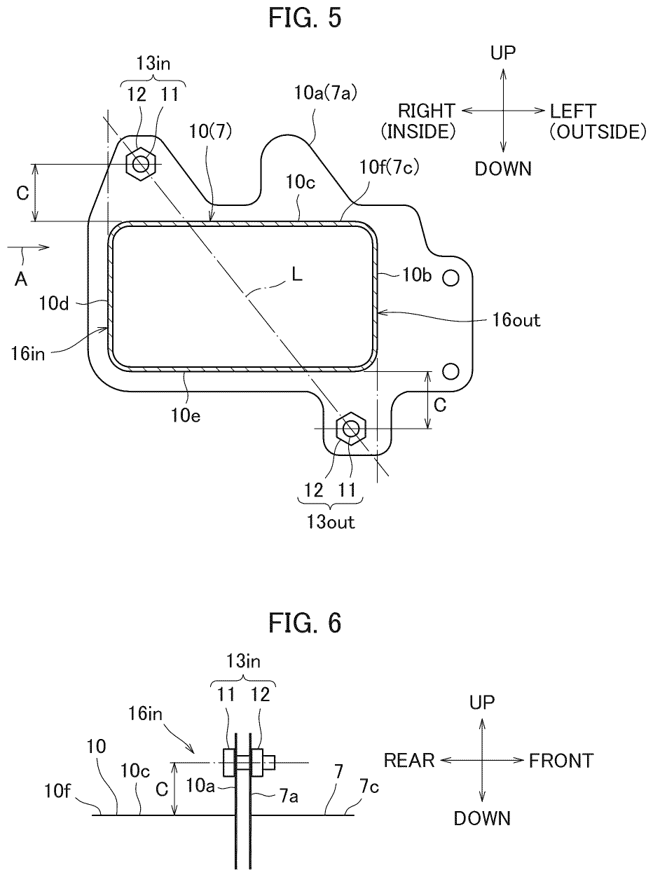

FIG. 5 is a cross-sectional view taken along a line V-V in FIG. 2 showing the arrangement of the inner and outer fastening portions with respect to the outer surface of the left front suspension member 7 and the lower crash box 10. FIG. 6 is a schematic diagram seen in a direction of an arrow A in FIG. 5, showing the flange portions 7a and 10a without deformation at a normal time. The following describes the connection structure between the front suspension member 7 and the lower crash box 10 via the flange portions 7a and 10a in more detail based on these figures.

To put it simply, the flange portions 7a and 10a are fastened at two points on a line L near the diagonal by the fastening portions 13in and 13out, and these fastening portions 13in and 13out are spaced apart from the outer surface of the body portion 7c of the front suspension member 7 and the outer surface of the body portion 10f of the lower crash box 10.

As shown in FIGS. 1 and 5, the body portion 10f of the lower crash box 10 has a rectangular cross section and extends in the front-rear direction. The front end of the body portion 7c of the front suspension member 7 also has the same cross-sectional shape as the body portion 10f of the lower crash box 10. Both members 7c and 10f are continuous in the front-rear direction by being connected via the flange portions 7a and 10a. Hereinafter, in connecting points each having a rectangular cross section, connecting points each corresponding to a side on the vehicle width inner side will be referred to as inner end portions 16in, and connecting points each corresponding to a side on the vehicle width outer side will be referred to as outer end portions 16out.

Hereinafter, the left lower crash box 10 shown in FIG. 5 will be described as an example. One fastening portion (hereinafter referred to as the inner fastening portion 13in) is spaced apart upwardly by a dimension C from the upper surface 10c of the body portion 10f of the lower crash box 10 (here, the upper surface 10c means also the upper surface of the body portion 7c of the front suspension member 7 that has the same cross-sectional shape, and the description means the same also hereinafter). In addition, the inner fastening portion 13in is arranged slightly to the left (the vehicle width outer side) of the inner side surface 10d of the body portion 10f of the lower crash box 10. The other fastening portion (hereinafter referred to as the outer fastening portion 13out) is spaced apart downwardly by the dimension C from the lower surface 10e of the body portion 10f of the lower crash box 10. In addition, the outer fastening portion 13out is arranged slightly to the right (the vehicle width inner side) of the outer side surface 10b of the body portion 10f of the lower crash box 10. The upper surface 10c of the body portion 10f of the lower crash box 10, from which the inner fastening portion 13in is spaced apart, corresponds to “an outer surface of a base portion of a first crash box” of the present invention. In addition, the upper surface of the body portion 7c of the front suspension member 7 corresponds to “an outer surface of a base portion of a front suspension member” of the present invention.

As a result, the line L connecting the fastening portions 13in and 13out diagonally crosses the cross section of the body portion 10f of the lower crash box 10, and the fastening portions 13in and 13out are arranged diagonally. Fastening diagonally in this manner reliably causes the flange portion 7a to be positionally coincide with the flange portion 10a, similarly to when the four corners are fastened. As a result, the body portion 10f of the lower crash box 10 can be fixed to and supported by the front end of the body portion 7c of the front suspension member 7 in a desired posture, and the decrease in the number of fastening portions 13in and 13out can reduce manufacturing cost. Although not shown or described, the connecting points between the right front suspension member 7 and the right lower crash box 10 are also symmetrical and have the same shape.

Although details will be described later, the arrangement of the fastening portions 13in and 13out as described above is intended to positively deform the flange portions 7a and 10a at a time of a slight-wrap frontal collision. Therefore, in the present embodiment, in order to further promote the deformation of the flange portions 7a and 10a, the wall thickness thereof is made smaller than the wall thickness applied to a typical flange portion. However, the setting of the wall thicknesses of the flange portions 7a and 10a are not limited to this, and can be changed to any thickness.

Furthermore, the arrangement of the inner fastening portion 13in and the outer fastening portion 13out with respect to the outer surface of the body portion 10f of the lower crash box 10 is not limited to the above. For example, different dimensions C may be applied respectively to the inner fastening portion 13in and the outer fastening portion 13out. Furthermore, the inner fastening portion 13in may be arranged at a lower position than the upper surface 10c of the body portion 10f of the lower crash box 10, and may be spaced apart from the inner side surface 10d of the body portion 10f of the lower crash box 10 to the right (vehicle width inner side). Furthermore, the outer fastening portion 13out may be arranged near the outer surface of the body portion 10f of the lower crash box 10 without being spaced apart from the outer surface.

The following describes effects of the front structure configured as described above at a time of a slight-wrap frontal collision of the vehicle.

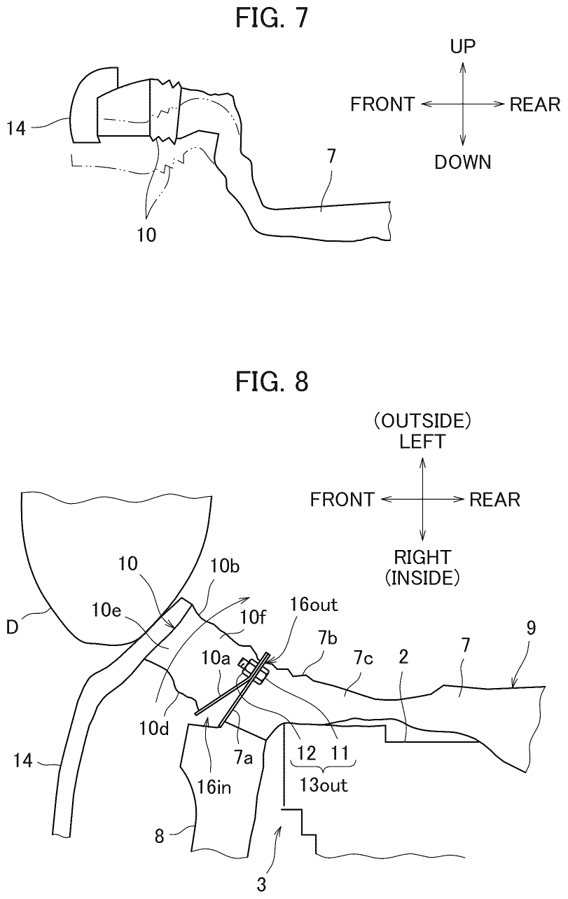

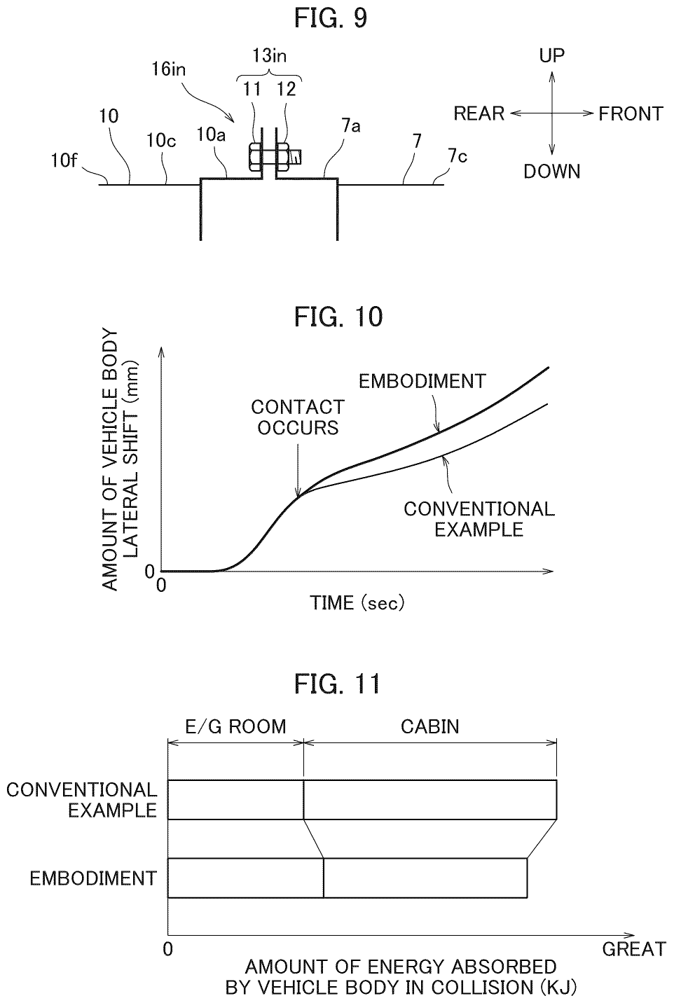

FIG. 7 is a side view showing a deformed state of the front suspension member 7 and the lower crash box 10 at a time of a slight-wrap frontal collision, FIG. 8 is a bottom view corresponding to FIG. 3 also showing a deformed state, and FIG. 9 is a schematic diagram corresponding to FIG. 6 also showing a deformed state of the flange portions 7a and 10a. Note that the following describes a case in which a slight-wrap frontal collision to the left side of the vehicle body occurs, but the same applies to a case in which a slight-wrap frontal collision to the right side thereof occurs.

When a slight-wrap frontal collision to the left side of the vehicle body occurs, the colliding object D shown by the dash-dot-dot line in FIGS. 3 and 4 collides with the left part of the left upper crash box 4 and the left part of the body portion 10f of the lower crash box 10 via the upper and lower bumper reinforcements 6 and 14, respectively. As a result, a collision load is input to the left part of the front end of the upper crash box 4, and a collision load is also input to the left part of the front end of the body portion 10f of the lower crash box 10. The upper crash box 4 has a shape that expands toward the left toward the front, and has the front end bulging out toward the left. This causes the colliding object D to be received by the upper crash box 4 and prevented from moving through to the rear even in the collision more to the left (in which the overlap amount is small).

At the initial stage of a frontal collision, the upper crash box 4, which is fastened at the four corners of the flange portions 1a and 4a, transmits the collision load to the front side member 1 side without collapsing. In contrast, the body portion 10f of the lower crash box 10 has only two fastening portions, but has the front end restrained from the upper crash box 4 side via the bumper reinforcement side 15. If the bumper reinforcement side 15 is not provided, the front end of the body portion 10f of the lower crash box 10 will collapse with downward displacement in a side view, as shown by the dash-dot-dot line in FIG. 7, for example. However, since such a phenomenon is prevented by the bumper reinforcement side 15, the body portion 10f of the lower crash box 10 also does not collapse as shown by a solid line in FIG. 7, and transmits the collision load to the front suspension member 7 side while providing a desired crushing to absorb the collision load. This can improve the load-bearing capacity in the front-rear direction of the vehicle body to reduce the vehicle body deformation amount.

If the frontal collision progresses further, the upper crash box 4 is gradually crushed by the collision load while being rotationally displaced from the posture shown by the solid line in FIG. 4 to the posture shown by the dash-dot-dot line in which the front end is moved to the left. The upper crash box 4, which has a shape that expands to the left, generates rotational force easily. The rotational displacement caused by the rotational force is efficiently transmitted to the body portion 10f of the lower crash box 10 via the bumper reinforcement side 15.

The body portion 10f itself of the lower crash box 10 also generates rotational force due to input of the collision load from the colliding object D to the left part of the body portion 10f, but the rotational force may be insufficient to generate rotational displacement. However, since the rotational force is transmitted from the upper crash box 4 via the bumper reinforcement side 15, as shown by the arrow in FIG. 8, the body portion 10f of the lower crash box 10 is also rotationally displaced in the same direction as the upper crash box 4, that is, so as to move the front end to the left. At this time, the body portion 10f of the lower crash box 10 is rotationally displaced around the outer end portions 16out, and accordingly, the flange portions 7a and 10a are bent and deformed at the outer end portions 16out, and the inner end portions 16in are spaced apart from each other.

The rotational displacement of the body portion 10f of the lower crash box 10 is allowed by the connection structure via the flange portions 7a and 10a as described above. Specifically, since the fastening portions 13in and 13out are respectively spaced apart by the dimension C from the upper surface 10c and the lower surface 10e of the body portion 10f of the lower crash box 10, the regions of the flange portions 7a and 10a located between these can be deformed, while maintaining the fastening by the fastening portions 13in and 13out. Therefore, even if the inner end portions 16in are spaced apart from each other due to the rotational displacement of the body portion 10f of the lower crash box 10, as shown in FIG. 9, the regions of the flange portions 7a, 10a are deformed which is located between the upper surface 10c of the body portion 10f of the lower crash box 10 and the inner fastening portion 13in, allowing the inner end portions 16in to be spaced apart from each other without damaging the inner fastening portion 13in.

Furthermore, even if flange portions 7a and 10a are bent and deformed at the outer end portions 16out due to rotational displacement of the body portion 10f of the lower crash box 10, the influence is gradually reduced in the region of the flange portions 7a and 10a between the lower surface 10e of the body portion 10f of the lower crash box 10 and the outer fastening portion 13out. This allows bending and deformation of the flange portions 7a and 10a at the outer end portions 16out without damaging the outer fastening portion 13out.

In particular, in the present embodiment, as shown in FIG. 5, the outer fastening portion 13out is arranged at a position slightly to the right of the outer side surface 10b of the body portion 10f of the lower crash box 10, in other words, at a position off to the right from an extension line of the outer end portions 16out. This reduces the mutual influence between the fastening by the outer fastening portion 13out, and the bending and deformation of the flange portions 7a and 10a at the outer end portions 16out.

In other words, the flange portions 7a and 10a are bent and deformed without being hindered by the outer fastening portion 13out, and even if the flange portions 7a and 10a are bent and deformed, the outer fastening portion 13out is hardly affected. This makes it possible to more reliably achieve prevention of damage to the outer fastening portion 13out and bending and deformation of the flange portions 7a, 10a at the outer end portions 16out. In addition, according to the arrangement of the outer fastening portion 13out shown in FIG. 5, the outer fastening portion 13out is sufficiently spaced apart from the inner fastening portion 13in. Therefore, the only two fastening portions 13in and 13out can align the flange portion 7a with the flange portion 10a more reliably.

The body portion 10f of the lower crash box 10 that has been rotationally displaced in this manner is sandwiched between the colliding object D and the vehicle body, as shown in FIG. 8. At this point, the body portion 10f of the lower crash box 10 has not been completely crushed. Therefore, the body portion 10f is placed between the colliding object D and the front end of the body portion 7c of the front suspension member 7 to press against both of them, and transmits the collision load input from the colliding object D to the front end of the body portion 7c of the front suspension member 7. This received collision load bends and deforms the body portion 7c of the front suspension member 7 toward the right. One side of the body portion 7c comes into contact with the power plant 2 while narrowing the gap S, and then presses the power plant 2 from the left. As a result, the collision load from the colliding object D is transmitted to the vehicle body via the body portion 10f of the lower crash box 10, the body portion 7c of the front suspension member 7, and the power plant 2. The transmitted collision load causes a lateral shift in which the entire vehicle body is moved to the right. In addition, in parallel with this, the upper and lower crash boxes 10, in which the crushing progresses, absorbs the collision load while transmitting the collision load to the front side member 1 side and the front suspension member 7 side. This improves the load-bearing capacity in the front-rear direction of the vehicle body and contributes to reducing the vehicle body deformation amount.

As shown in FIG. 3, the outer side surface 7b of the front region of the body portion 7c of the front suspension member 7 extends substantially linearly toward the front and toward the vehicle width outer side in order to prevent the colliding object D from moving through at a time of a slight-wrap frontal collision. This shape is also suitable for bending and deforming the body portion 7c of the front suspension member 7. In other words, rotational displacement of the body portion 10f of the lower crash box 10 gradually reduces the angle β between the outer side surface 10b of the body portion 10f and the outer side surface 7b of the body portion 7c of the front suspension member 7, and then makes the outer side surfaces 7b and 10b be substantially in a straight line as shown in FIG. 8. With this positional relationship, the collision load is transmitted from the body portion 10f of the lower crash box 10 to the front end of the body portion 7c of the front suspension member 7. Therefore, the collision load can be efficiently used for bending and deforming the body portion 7c of the front suspension member 7. This can increase the amount of vehicle body lateral shift, thereby further improving a vehicle body passing-over effect.

FIG. 10 is a diagram showing a result of a test comparing the occurrence of the amount of vehicle body lateral shift at a time of a slight-wrap frontal collision between the embodiment and a conventional example (including a typical upper and lower crash boxes). Unlike a full-wrap frontal collision, at a time of a slight-wrap frontal collision, the vehicle body does not receive the collision load head-on, and parries part of the collision load while laterally shifting in a direction of securing a gap with the colliding object D, thereby causing a so-called vehicle body passing-over effect. The lateral shift that occurs in the vehicle body at this time can be considered to be correlated with the strength of the vehicle body passing-over effect. As shown in the figure, when a slight-wrap frontal collision occurs, the lateral shift amount of the vehicle body gradually increases in both the present embodiment and the conventional example. In the present embodiment, the body portion 7c of the front suspension member 7 bends and deforms due to the rotational displacement of the body portion 10f of the lower crash box 10, to come into contact with the power plant 2. Therefore, after the contact, the lateral shift amount of the vehicle body increases more rapidly than in the conventional example, and a stronger vehicle body passing-over effect is obtained.

On the other hand, FIG. 11 is a diagram showing a result of a test comparing the amount of energy absorbed at a time of a slight-wrap frontal collision between the embodiment and the conventional example. It can be seen that the amount of energy absorbed by the engine room 3 is greater in the present embodiment than in the conventional example. The main cause is that the lower crash box 10, which is restrained by the bumper reinforcement side 15 to be prevented from collapsing, achieves the desired effect of absorbing the collision load and transmitting the load to the front suspension member 7.

Furthermore, in the present embodiment, the overall energy absorption amount is reduced compared to the conventional example, and the main cause is the improvement in the vehicle body passing-over effect as described above. This can significantly reduce the amount of energy absorbed by the cabin, together with the increase in the amount of energy absorbed by the engine room 3. This makes it possible to reduce the vehicle body deformation amount, especially the deformation amount of the cabin, at a time of a slight-wrap frontal collision.

Although the above describes a state in a slight-wrap frontal collision, a general offset frontal collision with a larger overlap amount (for example, 50%) also crushes each of the crash boxes 4 and 10 and transmits the collision load in a similar process, to provide a similar effect.

In addition, as described above, the body portion 10f of the lower crash box 10 is prevented from collapsing by restraint via the bumper reinforcement side 15. This provides the same effects as in a typical front structure in a full-wrap collision, though the details will not be described.

This concludes the description of the embodiment, but aspects of the present invention are not limited to this embodiment. For example, there may be a configuration such that: the number and arrangement of the fastening portions 13in and 13out on the flange portions 7a and 10a is changed; the bumper reinforcement side 15 is omitted; or each crash box 4 and 10, the front side member 1, the front suspension member 7, or the like is changed in shape.

### EXPLANATION OF REFERENCE SIGNS

1 front side member
4 upper crash box (second crash box)
7 front suspension member
7a flange portion
7c body portion (base portion)
9 subframe
10 lower crash box (first crash box)
10a flange portion
10c upper surface (outer surface)
10e lower surface (outer surface)
10f body portion (base portion)
13in inner fastening portion
13out outer fastening portion
15 bumper reinforcement side

1-8. (canceled)

9. A front structure of a vehicle, comprising:
a pair of left and right front suspension members that constitute a subframe of a vehicle body; and
a pair of left and right first crash boxes respectively connected to front ends of the respective front suspension members,
wherein each of the first crash boxes is connected to the front suspension member so that a front portion of the first crash box is rotationally displaced toward a vehicle width outer side when a collision load is input to the vehicle body due to an offset frontal collision,
the front suspension members and the first crash boxes each includes a base portion and a flange portion, the base portion extending in a vehicle body front-rear direction, the flange portion extending outward from an end portion of the base portion,
each front suspension member and the first crash box connected thereto respectively have the flange portions that are aligned with each other to be fastened by fastening portions at a plurality of positions,
the fastening portions include at least an inner fastening portion located on a vehicle width inner side and an outer fastening portion located on a vehicle width outer side,
the inner fastening portion is spaced apart from an outer surface of the base portion of the front suspension member and an outer surface of the base portion of the first crash box, and
the inner fastening portion and the outer fastening portion are arranged at only two positions diagonally in a cross section of the first crash box.

10. The front structure of the vehicle according to claim 9, further comprising:
a pair of left and right front side members respectively disposed above the front suspension members;
a pair of left and right second crash boxes respectively connected to front ends of the front side members; and
a pair of left and right bumper reinforcement sides that connects front ends of the first crash boxes and front ends of the second crash boxes on both left and right sides of the vehicle body, respectively.

11. The front structure of the vehicle according to claim 10,
wherein each of the second crash boxes has a shape that expands toward a vehicle width outer side toward front.

12. The front structure of the vehicle according to claim 10,
wherein each of the front suspension members has a base portion that has a front region with an outer side surface having a shape that extends toward front and toward a vehicle width outer side.

13. The front structure of the vehicle according to claim 9,
wherein the outer fastening portion is arranged on a vehicle width inner side relative to an outer end portion of the base portion of the front suspension member and an outer end portion of the base portion of the first crash box.

14. The front structure of the vehicle according to claim 9,
wherein a power plant of the vehicle is disposed on a vehicle width inner side of the front suspension members so as to be adjacent to the front suspension members.

15. The front structure of the vehicle according to claim 11,
wherein each of the front suspension members has a base portion that has a front region with an outer side surface having a shape that extends toward front and toward a vehicle width outer side.

16. The front structure of the vehicle according to claim 10,
wherein a power plant of the vehicle is disposed on a vehicle width inner side of the front suspension members so as to be adjacent to the front suspension members.

17. The front structure of the vehicle according to claim 11,
wherein a power plant of the vehicle is disposed on a vehicle width inner side of the front suspension members so as to be adjacent to the front suspension members.

18. The front structure of the vehicle according to claim 12,
wherein a power plant of the vehicle is disposed on a vehicle width inner side of the front suspension members so as to be adjacent to the front suspension members.

19. The front structure of the vehicle according to claim 13,
wherein a power plant of the vehicle is disposed on a vehicle width inner side of the front suspension members so as to be adjacent to the front suspension members.

20. The front structure of the vehicle according to claim 15,
wherein a power plant of the vehicle is disposed on a vehicle width inner side of the front suspension members so as to be adjacent to the front suspension members.
